(19) United States
(12) Patent Application Publication
(10) Pub. No.: US 2024/0075862 A1
(43) Pub. Date: Mar. 7, 2024

(54) TAILGATE TABLES

(71) Applicant: David Muti, Boonton Township, NJ (US)

(72) Inventor: David Muti, Boonton Township, NJ (US)

(21) Appl. No.: 17/930,066

(22) Filed: Sep. 6, 2022

(51) Int. Cl. B60N 3/00

(52) U.S. Cl. CPC B60N 3/001

(57) ABSTRACT

Described herein are examples of a system which includes a stow box, a base portion, an extension portion and a leg. The stow box forms a three-sided box sized to fit into a cargo space of a vehicle and includes a top surface for storage of items within the cargo space of the vehicle and on top of the stow box. The base portion translates into and out of an interior of the stow box without disturbing the items. The extension portion is pivotably is coupled to a first side of the base portion to lay atop the base portion for translation of the base portion into a stowed arrangement and to extend a surface area of the base portion in a deployed arrangement. The leg applies support to the at least one of the base portion and the extension portion, and displaces for the stowed arrangement.

### BACKGROUND

Storage and functional space within an interior of an automobile is a valuable resource. Vehicles are employed for simple commuting, for hauling of people and goods, for performing work functions, and the like. Some of the functions of the vehicle include traveling to a location where an event is held and transporting goods for use at the location of the event.

### BRIEF DESCRIPTION OF THE DRAWINGS

The present description will be understood more fully when viewed in conjunction with the accompanying drawings of various examples of tailgate tables. The description is not meant to limit the tailgate tables to the specific examples. Rather, the specific examples depicted and described are provided for explanation and understanding of tailgate tables. Throughout the description the drawings may be referred to as drawings, figures, and/or FIGs.

FIG. 1 illustrates a tailgate table in a fully deployed arrangement, according to an embodiment.

FIG. 2 illustrates the tailgate table of FIG. 1 in a partially deployed arrangement, according to an embodiment.

FIG. 3 illustrates the tailgate table of FIG. 1 in a stowed arrangement, according to an embodiment.

FIG. 4 illustrates a pivot table leg arrangement, according to an embodiment.

FIG. 5 illustrates a method of using the tailgate table of FIG. 1, according to an embodiment.

### DETAILED DESCRIPTION

Tailgate tables as disclosed herein will become better understood through a review of the following detailed description in conjunction with the figures. The detailed description and figures provide merely examples of the various embodiments of tailgate tables. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein.

A conventional table used for tailgating and other activities may include a stand-alone table that may be stored in a vehicle. When attending a sporting event, concert, auto-racing, and other similar events, people like to hang out and tailgate in the parking lot or the like. When doing so, many people will pack a conventional table in the form of a folding table to set food and drinks on. However, packing the back area of a vehicle with food, drink, chairs, and the like will usually require that these items be packed after the table is placed in the vehicle. This limits the space available in the vehicle and further requires that those goods be removed to allow for unloading of the table. Those items must be taken out of the vehicle and are usually placed on the ground to allow for the table to be removed and set up.

The reverse applies when packing the table and goods back up. Items must be removed from the table allow for taking the table down and stowing it in the vehicle. Placing items on the ground can damage, contaminate, or dirty the items. Similarly, a conventional table may be transported by placing the table atop the items as they are in the vehicle. This creates high-risk situation which, in response to movement of the vehicle or opening and closing of the vehicle, may result in harm to people in the vehicle, damage to the vehicle, the items, the table, or the like. Additionally, it can create a hazardous situation in which the table would slide out of the vehicle in response to opening the vehicle which may be dangerous.

Embodiments described herein provide a built into a self-contained arrangement which allows the table to be pulled out for use (and put back) without the need for removing or adjusting the position of any of the items packed above and/or around the tailgate table. Embodiments of the tailgate table may be drawn out to set up the tailgate table and load the items from the vehicle onto the table without requiring removal of the items from the vehicle to access the tailgate table. Setup is intuitive and elegant. Stowing the table is equally intuitive and elegant.

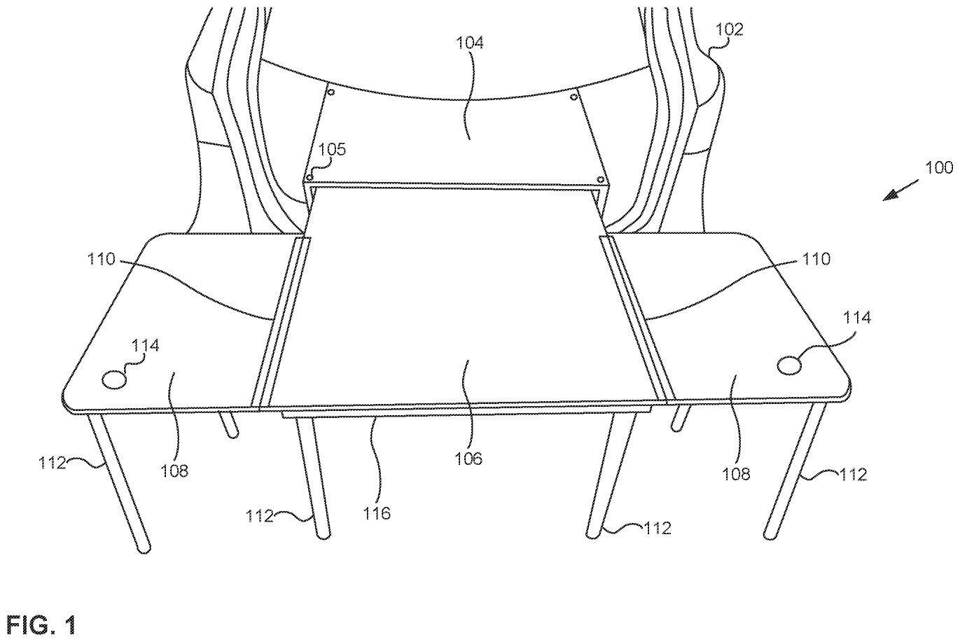

FIG. 1 illustrates a tailgate table 100 in a fully deployed arrangement, according to an embodiment. Embodiments of the tailgate table 100 are accessible from a cargo area of a vehicle 102.

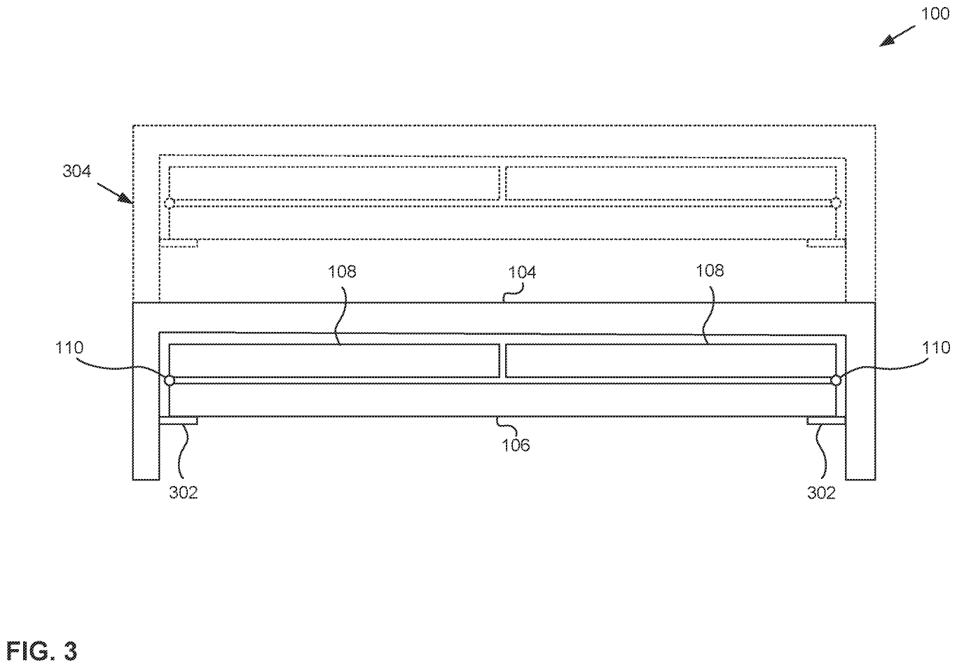

In some embodiments, the tailgate table 100 extends from stow box 104 positioned in the cargo area of the vehicle 102. In some embodiments, the stow box 104 may be secured relative to the vehicle with straps, hooks, bolt, spikes, teeth, roughening, and the like. In some embodiments, the stow box 104 may include hardware 105 to facilitate a stackable arrangement with another stow box 104, tailgate table 100, or other structure. In some embodiments, the hardware 105 may be used to accept and/or align the stackable arrangement as shown in FIG. 3. The hardware 105 may be covered with caps or other plugs to reduce the chance of items or objects interfacing with the hardware 105 or to secure a cover, mat, or other structure relative to the stow box 104. The stow box 14 may also include hardware to level the stow box 104 wherein/relative to the vehicle 102 and/or align the stow box 104 with a sill or lip of the cargo area of the vehicle 102. For example, leveling screws may be incorporated into the stow box 104.

In some embodiments, the stow box 104 provides a location to contain the tailgate table 100 in a stowed arrangement and support the tailgate table 100 in a deployed arrangement. The stow box 104 may also form a storage platform to support items placed on top of the stow box 104 without impacting deployment or stowage of the tailgate table 100 from or into the stow box 104. In some embodiments, a mat or other traction surface or surface treatment may be applied to the stow box 104 to improve cargo handling. This may be incorporated with the hardware 105 or may be independent of the hardware 105. The stow box 104 may also include a handle, groove, or similar structure to facilitate gripping of the stow box 104 for removal of the tailgate table 100 from the vehicle 102 or placement into the vehicle 102.

The tailgate table 100 may include a main portion 106 and one or more extension portions 108. The main portion 106 may couple to the stow box 104 in a slidable relationship. In other words, the main portion 106 may be configured to slide into and out of the stow box 104. In some embodiments, the main portion 106 may be coupled to the stow box 104 via drawer glides, slide channels, wheels, friction surfaces, or the like.

In some embodiments, the extension portions 108 are coupled to the main portion 106 to be pivotable relative to the main portion 106. For example, the extension portions 108 may be coupled to the main portion 106 via a hinge 110. The hinge 110 may be a piano hinge, multiple hinges, or so forth. The extension portions 108 may be sized to fit across the main portion 106 when pivoted to lay across the main portion 106. This may facilitate fitment within the stow box 104.

In some embodiments, the extension portions 106 may be sized to approximate a width of the vehicle in the deployed arrangement. Other sizes that result in a size greater than or less than the vehicle may also be incorporated. The main portion 106 and the extension portions may be made of a natural material, synthetic material, or a composite of natural and/or synthetic materials. For example, one or more of the main portion 106 and the extension portions 108 may include a corrugated reinforced plastic to provide relatively low weight and high strength.

In some embodiments, the tailgate table 100 includes legs 112. In some embodiments, the tailgate table 100 includes one or more legs positioned on the tailgate table 100 to support the main portion 106 and/or extension portions 108 in the deployed arrangement and fold or be removed during a stowed arrangement. The legs 112 may be adjustable in length. For example, the legs 112 may be telescoping, have removable sections, be of different lengths, or so forth. Adjustability of the legs 112 may incorporate set screws, spring pins, buttons, clamps, friction locks, flick locks, twist locks, threads, or so forth.

In some embodiments, the legs 112 may be lockable in one or more positions relative to the main portion 106 and/or extension portions 108. For example, the legs 112 may be lockable to prevent unintended collapse of the legs 112 while supporting the tailgate table 100 or to maintain the legs 112 in a stowed position to allow for stowing of the tailgate table 100 within the stow box 104.

In some embodiments, the tailgate table 100 may include accessory mounting locations 114 to allow for attachment of accessories such as tents, bag/anchor hooks, bottle openers, umbrellas, canopies, cupholders, chargers, cables, and so forth. These locations 114 may be added structures or removed material in the tailgate table 100 and may be formed in one or more of the main portion 106 and/or the extension portions 108. Caps or filters may also correspond to locations 114.

In some embodiments, the tailgate table 100 may include a lip 116. The lip 116 may be sized and/or positioned on the main portion 106 and/or extension portions 108 to facilitate structural support of the tailgate table 100 and/or grippable surface for stowage or deployment of the tailgate table 100 from the stow box 104. The lip 116 may be removable or non-removable.

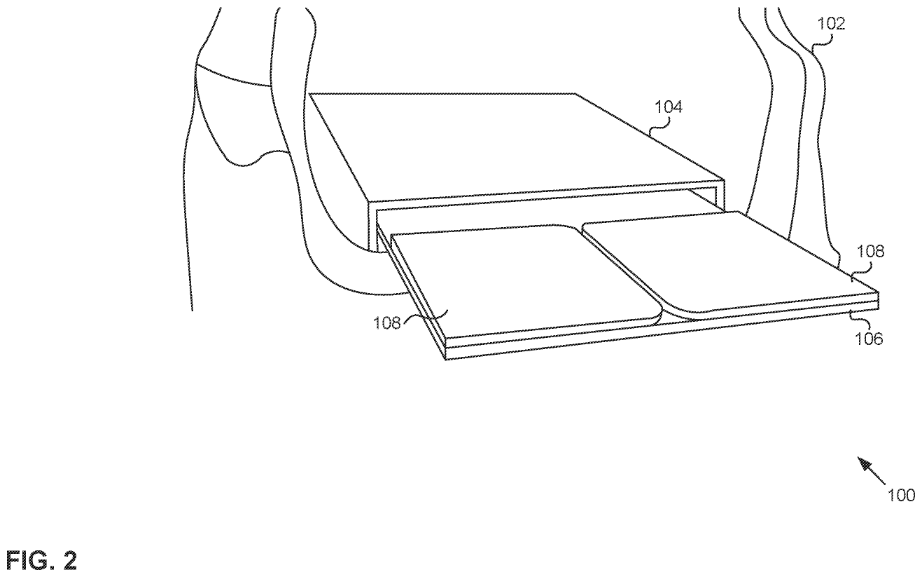

FIG. 2 illustrates the tailgate table 100 of FIG. 1 in a partially deployed arrangement, according to an embodiment. Embodiments provide a table which may be easily deployed from and stowed into a vehicle 102.

In some embodiments, the extension portions 108 pivot over top of the main portion 106 to form a flat-folded arrangement for easy and intuitive operation relative to the stow box 104 within the vehicle 102. The extension portions 108 allow for an increase in surface area toward the sides of the vehicle in addition to the main portion 106 without requiring an increase or extension rearward of the vehicle forming a further continuation of the main portion 106 as such may impede foot or vehicular traffic around a rear of the vehicle 102 or otherwise require a relatively large amount of clearance behind the vehicle 102. In some embodiments, the tailgate table 100 includes rounded corners, bumpers, pinch guards, and the like to reduce the chance of injury when interfacing with the tailgate table 100 or when around the tailgate table 100.

FIG. 3 illustrates the tailgate table 100 of FIG. 1 in a stowed arrangement, according to an embodiment. Embodiments may provide a compact storage arrangement to reduce space occupied by the tailgate table 100.

In some embodiments, the tailgate table 100 includes sliding hardware 302 positioned between the main portion 106 and the stow box 104 to allow for translation relative to the stow box 104 when deploying or storing the tailgate table 100. The sliding hardware 302 may include glides, slides, friction surfaces, or the like. In some embodiments, the stow box 104 may provide for space below the main portion 106 of the tailgate table 100 when stowed to allow for space for legs, accessories, hardware, or the like within the stow box 104 and below the main portion 106 of the tailgate table 100.

In some embodiments, the tailgate table 100 may be stacked with a second stow box, table, or the like as shown by stacked element 304. This may be used as additional storage for tables, legs, loose items, crushables, or the like to increase storage and provide containment.

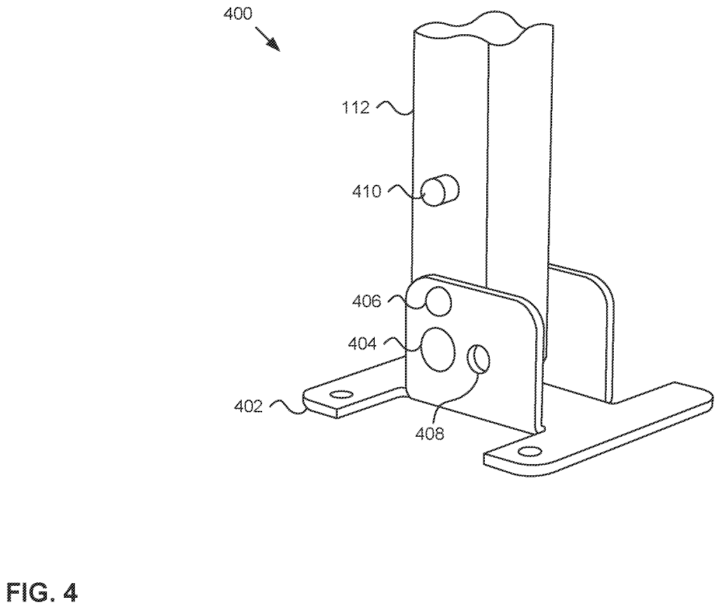

FIG. 4 illustrates a pivot table leg arrangement 400, according to an embodiment. Embodiments may allow for a stowable arrangement that is easily transposable.

In some embodiment, the leg 112 is coupled to a pivot structure 402. The pivot structure 402 may be configured to attach to at least one of the main portion 106 or the extension portion 108. In some embodiments, the pivot structure 402 includes a mounting arrangement such as through-holes, hardware, or other structure. In some embodiments, the pivot table leg arrangement 400 includes a pivot element 404. The pivot element 404 may include a pin, bolt, rod, or other structure about which the leg 112 may pivot from a first position to a second position. The pivot element 404 may be removable or fixed.

In some embodiments, the pivot table leg arrangement 400 includes a securing mechanism 406. The securing mechanism 406 may provide a securing force to secure the leg 112 in the first position or the second position based on how the securing mechanism is aligned with securing apertures 408 in the pivot structure 402. In some embodiments, the securing mechanism 406 is a spring tab, a clip, a pin, or the like.

In some embodiment, the pivot table leg arrangement 400 includes a length adjustment mechanism 410. The length adjustment mechanism 410 may be similar in operation to the securing mechanism 406. In other embodiments, the length adjustment mechanism 410 may be distinct in operation to the securing mechanism 406. In some embodiments, the length adjustment mechanism 410 may engage with another section of the leg 112 to set a length of the leg 112.

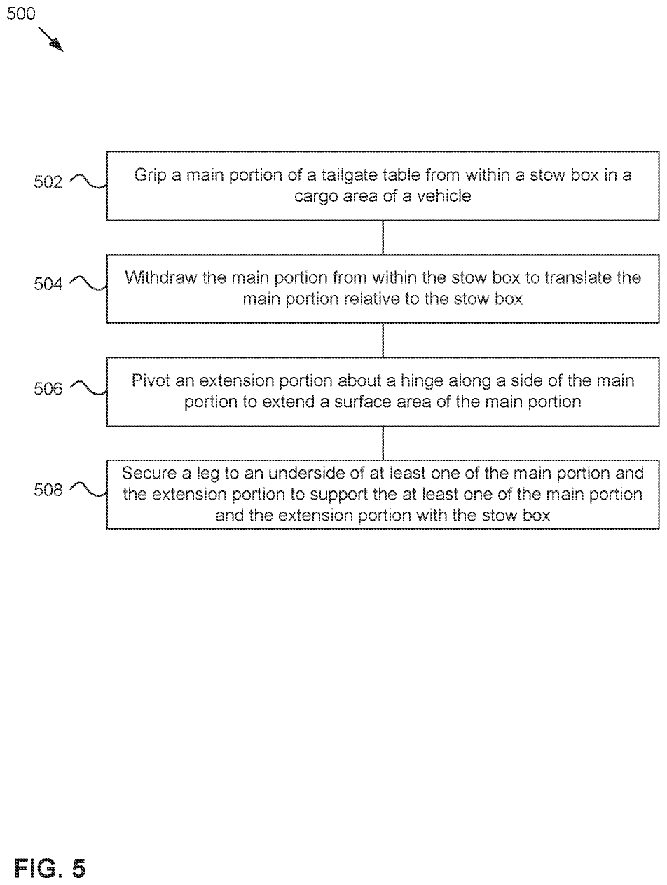

FIG. 5 illustrates a method 400 of using the tailgate table 100 of FIG. 1, according to an embodiment. Embodiments provide an intuitive and flexible table arrangement for use with a vehicle.

In some embodiments, the method 400 may include gripping a main portion of a tailgate table from within a stow box in a cargo area of a vehicle (Block 402). The main portion may be hand-grippable and include structure to improve grippability. Embodiments may include lips, cutouts, handles, straps, tabs, ropes, loops, and the like.

The method 400 may include withdrawing the main portion from within the stow box to translate the main portion relative to the stow box (Block 404). In some embodiments, the main portion may be coupled to the stow box via glides, slides, rails, or the like to allow for translation of the main portion into and out of the stow box.

The method 400 may include pivoting an extension portion about a hinge along a side of the main portion to extend a surface area of the main portion (Block 406). In some embodiments, the extension portion may rest upon a top surface of the main portion while positioned within the stow box and then pivot about the hinge to align with the top surface of the main portion in a deployed arrangement to extend the top surface of the main portion.

The method 400 may include securing a leg to an underside of at least one of the main portion and the extension portion to support the at least one of the main portion and the extension portion with the stow box. In some embodiments, the leg may be permanently coupled to the main portion or the extension portion and moved into position during deployment of the tailgate table.

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure.

Elements of processes (i.e. methods) described herein may be executed in one or more ways such as by a human, by a processing device, by mechanisms operating automatically or under human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely exemplary. Particular implementations may vary from these exemplary details and still be contemplated to be within the scope of the present implementations.

Related elements in the examples and/or embodiments described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims. Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

Where multiples of a particular element are shown in a FIG., and where it is clear that the element is duplicated throughout the FIG., only one label may be provided for the element, despite multiple instances of the element being present in the FIG. Accordingly, other instances in the FIG. of the element having identical or similar structure and/or function may not have been redundantly labeled. A person having ordinary skill in the art will recognize based on the disclosure herein redundant and/or duplicated elements of the same FIG. Despite this, redundant labeling may be included where helpful in clarifying the structure of the depicted examples.

The Applicant(s) reserves the right to submit claims directed to combinations and sub-combinations of the disclosed examples that are believed to be novel and non-obvious. Examples embodied in other combinations and sub-combinations of features, functions, elements and/or properties may be claimed through amendment of those claims or presentation of new claims in the present application or in a related application. Such amended or new claims, whether they are directed to the same example or a different example and whether they are different, broader, narrower or equal in scope to the original claims, are to be considered within the subject matter of the examples described herein.

1. A system, comprising:
a stow box forming a three-sided box sized to fit into a cargo space of a vehicle and comprising a top surface for storage of items within the cargo space of the vehicle and on top of the stow box;
a base portion sized to translate into and out of an interior of the stow box without disturbing the items;
an extension portion pivotably coupled to a first side of the base portion to lay atop the base portion for translation of the base portion into a stowed arrangement and to extend a surface area of the base portion in a deployed arrangement; and
a leg configured to:
couple to an underside of at least one of the base portion and the extension portion;
apply support in the deployed arrangement; and
displace to allow for translation of the base portion into the stowed arrangement within the stow box.

2. The system of claim 1, wherein the base portion is coupled to the stow box via a glide coupled to an underside of the base portion.

3. The system of claim 1, further comprising a second extension portion pivotably coupled to a second side of the base portion opposite the first side of base portion, wherein the second extension portion lays atop the base portion parallel to the extension portion in the stowed arrangement and extends the surface area of the base portion parallel to the extension portion in the deployed arrangement.

4. The system of claim 1, further comprising a hinge pivotably coupling the extension portion to the base portion.

5. The system of claim 1, wherein the stow box further comprises hardware configured to level the stow box within the vehicle.

6. The system of claim 1, wherein the stow box further comprises hardware configured to align the stow box with the cargo space of the vehicle to allow for translation of the base portion from within the stow box.

7. The system of claim 1, wherein the stow box further comprises structure to secure the stow box relative to the cargo area of the vehicle.

8. The system of claim 1, wherein the stow box further comprises grippable structure to facilitate movement of the stow box into or out of the cargo area of the vehicle.

9. The system of claim 1, wherein the base portion further comprises a lip positioned on the base portion to be distal from the stow box in the deployed arrangement and configured to be grippable for manipulation of the base portion into and out of the deployed arrangement relative to the stow box.

10. The system of claim 1, wherein at least one of the base portion and the extension portion comprises an accessory mounting location configured to position an accessory relative to the at least one of the base portion and the extension portion.

11. A device, comprising:
a base portion sized to translate into and out of an interior of a stow box shaped to fit a cargo area of a vehicle;
an extension portion pivotably coupled to a first side of the base portion to lay atop the base portion for translation of the base portion into a stowed arrangement and to extend a surface area of the base portion in a deployed arrangement; and
a leg configured to:
couple to an underside of at least one of the base portion and the extension portion;
apply support in the deployed arrangement; and
displace to allow for translation of the base portion into the stowed arrangement within the stow box.

12. The device of claim 11, wherein at least one of the base portion and the extension portion comprises a reinforce corrugated plastic.

13. The device of claim 11, wherein the leg is telescoping to adjust a length of the leg.

14. The device of claim 13, wherein the leg comprises a set screw to secure the leg at the adjusted length.

15. The device of claim 11, wherein the leg is pivotably coupled to the at least one of the base portion and the extension portion to be positioned parallel to the base portion in the stowed arrangement and perpendicular to the base portion in the deployed arrangement.

16. The device of claim 11, wherein the leg is fixed to the at least one of the base portion and the extension portion to be positioned below the base portion within the stow box in the stowed arrangement.

17. The device of claim 11, wherein the leg is lockable into a position that is at least one of parallel to the main portion and perpendicular to the main portion.

18. The device of claim 11, further comprising a canopy coupleable to the at least one of the base portion and the extension portion.

19. The device of claim 11, further comprising a bag/anchor hook coupled to the at least one of the base portion and the extension portion.

20. A method, comprising:
gripping a main portion of a tailgate table from within a stow box in a cargo area of a vehicle;
withdrawing the main portion from within the stow box to translate the main portion relative to the stow box;
pivoting an extension portion about a hinge along a side of the main portion to extend a surface area of the main portion; and
securing a leg to an underside of at least one of the main portion and the extension portion to support the at least one of the main portion and the extension portion with the stow box.
